(19) United States
(12) Patent Application Publication
(10) Pub. No.: US 2019/0321886 A1
(43) Pub. Date: Oct. 24, 2019

(54) METHOD FOR THE ADDITIVE PRODUCTION OF A COMPONENT AND COMPUTER-READABLE MEDIUM

(71) Applicant: Siemens Aktiengesellschaft, Munich (DE)

(72) Inventor: Ole Geisen, Berlin (DE)

(73) Assignee: Siemens Aktiengesellschaft, Munich (DE)

(21) Appl. No.: 16/344,446

(22) PCT Filed: Oct. 18, 2017
(86) PCT No.: PCT/EP2017/076538

§ 371 Date: Apr. 24, 2019

(30) Foreign Application Priority Data
Nov. 16, 2016 (DE) 10 2016 222 555.3

(51) Int. Cl. B22F 3/105; B33Y 10/00; B33Y 50/02

(52) U.S. Cl. CPC B22F 3/1055; B33Y 10/00; B33Y 50/02; B22F 2003/247; B22F 2301/15; B22F 2003/1058; B22F 2003/1057

(57) ABSTRACT

A method for the additive production of a component, includes recording of a component geometry of a first region, to be produced additively, of the component, transfer of a construction geometry, derived from the recorded component geometry, into a processing region of a construction platform, mechanical processing of the construction platform in the processing region in such a way that the construction geometry is transferred into the structure of the construction platform so that a construction surface for the component is defined by the construction geometry, and additive construction of the component on the construction surface. A computer-readable medium implements the method for the additive production of the component.

### CROSS REFERENCE TO RELATED APPLICATIONS

This application is the US National Stage of International Application No. PCT/EP2017/076538 filed Oct. 18, 2017, and claims the benefit thereof. The International Application claims the benefit of German Application No. DE 10 2016 222 555.3 filed Nov. 16, 2016. All of the applications are incorporated by reference herein in their entirety.

### FIELD OF INVENTION

The present invention relates to a method for the additive production of a component, and to a computer-readable medium containing executable program instructions. The method may be a part of an additive production method or an auxiliary method or a preparatory method for the additive production of the component.

### BACKGROUND OF INVENTION

Generative or additive production methods comprise, for example, as powder bed methods selective laser melting (SLM) or laser sintering (SLS), or electron beam melting (EBM). Additive methods likewise include laser deposition welding (LMD).

Additive manufacturing methods have proven particularly advantageous for complex or complicated or filigree-designed components, for example labyrinth-like structures, cooling structures and/or lightweight structures. In particular, additive manufacture is advantageous due to a particularly short chain of process steps, since a step of production or manufacture of a component can be carried out directly on the basis of a corresponding CAD file.

Furthermore, additive manufacture is particularly advantageous for the development or production of prototypes which, for example, cannot be produced, or cannot be produced efficiently, for cost reasons by means of conventional subtractive or machining methods or casting technology.

Despite the increasing industrial importance of additive manufacture, there are difficulties in the process economy, in particular in the construction times. This applies in particular for the field of components exposed to high temperatures.

A method for selective laser melting is known, for example, from EP 2 601 006 B 1.

For manufacturing reasons, there is furthermore a constraint to the additive construction of a certain oversize region as a foundation or substrate for the actual component, in order, for the subsequent detachment and/or finishing of the constructed component, to allow leeway on the one hand for the separation (from the substrate) and on the other hand for mechanical finishing, which is usually still required in the case of highly complex filigree parts. The construction of a solid “support” or oversize region, however, because it often needs to be constructed surface-wide on the construction platform or the corresponding intended region, for example 5 mm, thereof, requires a particularly long amount of time as well as costs. This means, in particular, high costs when the aforementioned components are manufactured from high-performance materials. In particular, the costs for nickel-based alloys and/or superalloys are high.

### SUMMARY OF INVENTION

It is therefore an object of the present invention to provide means with which the aforementioned disadvantages can be overcome. In particular, a method is proposed with which the additive construction of the aforementioned “supports” can be at least partially or regionally avoided or restricted, and costs and construction time can thus be saved significantly.

This object is achieved by the subject matter of the independent patent claims. Advantageous configurations are the subject matter of the dependent patent claims.

One aspect of the present invention relates to a method for the additive production of a component, comprising recording of a component geometry of a first region, to be produced additively, of the component. As an alternative thereto—in the case of producing a multiplicity of components—a multiplicity of component geometries may correspondingly also be recorded.

The method is advantageously a powder bed-based method, advantageously selective laser melting, selective laser sintering or electron beam melting. A common feature of the aforementioned methods is a single defined construction direction.

The first region advantageously refers to a region of the component from one or a few layers constructed first along the construction direction. The first region may correspondingly refer to a bottom region of the component.

The method furthermore comprises projection or transfer of a construction geometry, derived from the recorded component geometry, into a processing region of a construction platform.

The processing region is advantageously a region of the construction platform, for example in the direction of the aforementioned construction direction. The processing region is advantageously furthermore a region in which the construction platform can be processed mechanically (by removing material) in a subsequent step.

In one configuration, the construction geometry is derived from the recorded component geometry during the transfer by providing the construction geometry with a predetermined lateral dimension.

The method furthermore comprises mechanical, in particular material-removing, processing, for example ablation by milling, of the construction platform in the processing region or lateral sections thereof in such a way that the construction geometry is transferred into a structure of the construction platform, specifically in such a way that a construction surface for the component is defined by the construction geometry.

The method furthermore comprises the additive construction of the component on the construction surface. In this case, the additive construction may comprise a subsequent heat treatment, for example in order to reduce mechanical stresses which have been generated during the construction.

The advantage of projection of the component geometry, at least in the lower part of the component and/or its transfer into the substrate, advantageously makes it possible, in conjunction with the mechanical processing, instead of the expensive component materials, which furthermore must be constructed additively in an elaborate way (as described above) in order to carry out a separation step for separating the component and/or mechanical finishing in the material of the substrate or of the construction platform. Since the structure of the construction platform is present anyway, and the material is furthermore usually more economical than the expensive materials to be constructed additively, in an effective way both the construction time for the entire construction process can be reduced significantly and the “waste” of expensive base material for the processing region can be avoided. As a further advantage, the material of the platform is often likewise easier to process mechanically than the component materials, which are in particular hardened. At least for some separating methods, an advantage is obtained in this way.

Particularly in the case of complicated and expensive materials, for example for the hot-gas area of gas turbines, the construction platform, in particular because of the required heat treatment of the component alloys, cannot anyway, or not always, be reused, so that mechanical removal of material from the construction platform is acceptable, or does not entail any disadvantage.

In one configuration, the recording of the component geometry and/or the transfer of the construction geometry is carried out with computer assistance and/or by a data processing program, for example software. The program and/or the software may be software of an optical recording or scanning method, or design software. In this case, design data (for example CAD/CAM data), which are often present in the scope of additive manufacture already divided into construction layers (“slicing”) before the actual construction process, may be employed.

In one configuration, the projection of the derived construction geometry is output automatically or semiautomatically by a data processing program or software to a tool for the subsequent mechanical processing of the construction platform, for example to a CNC milling machine or another corresponding tool.

Accordingly, the described method may at least partially be computer-implemented.

In one configuration, the mechanical processing is carried out by milling or cutting.

In one configuration, the processing region represents an oversize region on the surface of the construction platform, over or in which, after the construction of the component, separation thereof, as well as mechanical finishing for the component or of the component, may be carried out. In other words, excess material for the separation and the finishing is already provided in the structure of the construction platform, and this is advantageously automatically recorded and output by software or a machine controller.

In one configuration, the method comprises—after the additive construction—separation of the (constructed) component from the construction platform in the processing region, in particular by at least one of the following methods: erosion, sawing, milling, grinding and striking.

In one configuration, during the transfer, a thickness of the processing region is selected as a function of a separation method (see above) for the subsequent separation of the component, and a selection of values is automatically proposed for the thickness. The proposed values may, for example, subsequently be selected by a user or an operator according to the specific requirements of the processing.

In one configuration, the thickness of the processing region is between 3 and 10 mm, in particular 5 mm, advantageously measured parallel to the construction direction. This configuration normally allows sufficient space in order both to provide a separation step and to be able to carry out mechanical finishing.

In one configuration, the additive construction is carried out by a powder bed-based method, in particular selective laser melting.

In one configuration, surface regions of the construction platform which were exposed by the mechanical processing are coated with a base material in powder form for the component, without, as is usual in the case of conventional additive methods, the construction platform being lowered stepwise.

In one configuration, the component is provided with a cavity during the additive construction.

In one configuration, the component is constructed in such a way that the cavity is open only on a side facing toward the construction platform (in the interior).

In one configuration, the cavity is mechanically opened before subsequent separation of the constructed component from the construction platform and before a heat treatment of the component, for example by boring or sawing, in such a way that a base material in powder form for the component, which has correspondingly been enclosed in the cavity during the additive construction, can be removed through the construction platform.

This configuration makes it possible, advantageously before the heat treatment and before a separation step (separation of the component from the construction platform), to avoid mechanical material-removing processing of the component solid body. In this way, crack formation in the component or even destruction can in turn be prevented since the latter is most probably highly stressed or otherwise mechanically loaded after the additive construction and a corresponding cooling.

The reason why heat treatment is generally carried out before the separation of the component is the stabilizing effect of the substrate plate. The advantageously solid substrate plate holds the constructed component. Without a so-called “stress-relief anneal”, i.e. a heat treatment to relax stresses, the internal stresses which are created during the SLM process would lead to irreversible deformation of the component shape during the separation.

Mechanical processing of the usually softer substrate material or platform material is in this case less risky. The proposed method therefore makes it possible for the first time to remove powder from the described internal cavities of the component without incurring the risk of destruction by cracks.

Although the stresses created during the construction are reduced again during a heat treatment, the powder would then also become sintered, so that it may possibly no longer be removable from the cavity.

In one configuration, the construction platform comprises steel as a main constituent.

In one configuration, the component is produced from a superalloy and/or a nickel-based alloy.

In one configuration, the method comprises the parallel additive construction of a multiplicity of components, a multiplicity of component geometries being recorded and a multiplicity of derived construction geometries correspondingly being projected or transferred into the processing region. Furthermore, the construction platform is mechanically processed according to the multiplicity of construction geometries and the multiplicity of components are additively constructed on the corresponding construction surfaces (as described above with reference to a component).

A further aspect of the present invention relates to a computer-readable medium comprising executable program instructions or commands which are suitable for enabling a data processing device or a computer carry out the described method, or at least the described recording and transfer.

A further aspect of the present invention relates to a computer program product comprising executable program instructions or commands which, when the program is run by a computer or a data processing device, make the latter carry out the described method, or at least the described recording and transfer.

Configurations, features and/or advantages which relate here to the method may furthermore apply to the computer-readable medium, or vice versa.

### BRIEF DESCRIPTION OF THE DRAWINGS

Further details of the invention are described below with the aid of figures.

FIG. 1 shows a schematic sectional view of a component at least partially constructed on a construction platform.

FIG. 2 shows a schematic sectional view of a component according to the invention at least partially constructed on a construction platform.

FIG. 3 shows a schematic plan view of a construction platform on which a multiplicity of components have been at least partially constructed according to the invention.

FIG. 4 shows a schematic flowchart which indicates method steps of the method according to the invention.

### DETAILED DESCRIPTION OF INVENTION

In the exemplary embodiments and figures, elements which are the same or have the same effect may respectively be provided with the same references. The elements represented and their size proportions with respect to one another are in principle not to be regarded as true to scale; rather, individual elements may be represented exaggeratedly thick or largely dimensioned for better representability and/or for better comprehensibility.

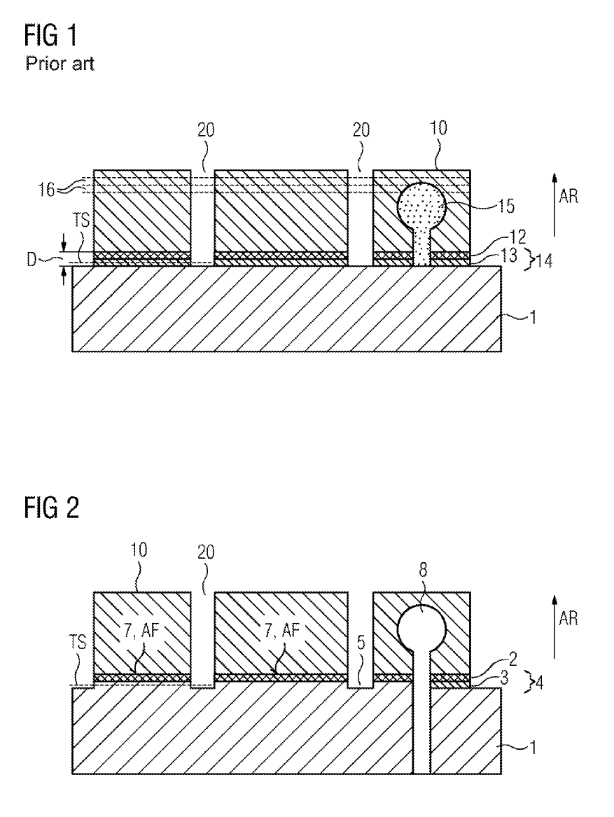

FIG. 1 shows a construction platform 1. A component 10 is arranged on the construction platform 1. The component 10 is at least partially constructed according to the invention on a construction platform 1 by means of an additive production method, advantageously by means of a powder bed-based method such as selective laser melting, or another method.

The component 10 is advantageously intended for use in a turbomachine, advantageously in the hot-gas path of a gas turbine. The component advantageously consists of a nickel-based alloy or superalloy, in particular a nickel-based or cobalt-based superalloy. The alloy may be precipitation-hardened or precipitation-hardenable. Accordingly, a base material, particularly in powder form, may be provided for the component 10.

The method described with the aid of FIG. 1 may be a method of the prior art.

With the aid of the dashed horizontal lines in the upper region of the component 10, the intention is to indicate that the component has been constructed from individual layers 16 or layerwise, or by layerwise solidification of individual applied powder layers. The solidification is advantageously carried out correspondingly using a laser beam or electron beam, as described above.

In the right-hand section, the component 10 comprises a cavity 8. The cavity 8 is for example still filled with a base material 15 in powder form, which has not been solidified according to the geometry of the component. In the regions 20, the base material 15 has subsequently been removed, for example by blowing out. Since the cavity 8 is open only to a side facing toward the construction platform 1, or at least is intended an opening there after the separation, it has not been possible to remove the powder 15 from the cavity 8.

The component 10 is represented in three lateral sections, which are structurally not connected. The component is, however, advantageously not represented fully constructed. Other than as represented, the component 10 may be constructed in the upper part in such a way that the three sections of the component 10 are structurally combined. The component furthermore comprises a processing region 14. The processing region 14 is a region of the component 10 which extends along a construction direction AR thereof.

The processing region 14 may be an oversize region. The processing region 14 furthermore comprises a finishing region 12 and a separation region 13. In the finishing region 12, the component is advantageously finished after separation from the construction platform 1 by expedient methods. The finishing may refer to a surface treatment or even further material-removing processing of the corresponding surface of the component.

In the separation region 13, in contrast thereto, a separation step to separate the component 10 from the construction platform 1 is advantageously used. In particular, the component 10 may be separated from the construction platform 1 by sawing, milling, grinding, erosion and/or subsequent striking.

The thickness D of the processing region 14 may for example be between 3 mm and 10 mm, in particular 5 mm, in order to provide sufficient leeway for the separation step. In the case of a nominal layer thickness of 40 μm, 125 coating and solidification processes would thus be required. In the case of a duration of one minute per layer during the additive production, this would entail time expenditure of more than two hours.

According to the method described with the aid of FIG. 1, the entire processing region 14 for a bottom surface of the component 10 must also be additively constructed, even though it is subsequently removed (again) either by separation or finishing. Since conventional layer thicknesses of components standardly constructed by selective laser melting lie in the range of between 20 μm and 40 μm, for a 5 mm thick processing region at least 150 material layers (without taking into account a welding shrinkage) must be elaborately solidified from powder. This elaborate material construction of material to be removed (again) later is not only unfavorable for reasons of time. Because the component material is often particularly solid and loadable, separation or even finishing of material in the processing region 14 is furthermore made difficult by the material properties.

A solution according to the invention to the problem is described with the aid of the following figures.

In particular, in contrast to FIG. 1, FIG. 2 shows a situation in which a component 10 was constructed without “wasting” valuable materials and construction times, a processing region 4 already being provided in the structure of the construction platform 1.

In the scope of the described method, a component geometry, in particular a geometry of the component along the first layer to be solidified or along a first region to be produced additively, is thus first recorded (cf. method step a) in FIG. 4). This may be done by an optical scanning method and/or implemented by software technology, in which case CAD (computer-aided design) data and/or CAM (computer-aided manufacturing) data may also simply be employed. The first region to be produced additively may, for example, also relate only to the first material layer to be solidified for the component.

In the scope of the present invention, provision is also made to incorporate the entire functionality of the described method into corresponding control software for a corresponding production system. The production process, i.e. comprising the orientation of the components and their positioning on the construction platform, may for example also be set up in the control and/or design software or a corresponding computer implementation of the described method into system hardware.

This region is then transferred or projected by data technology, advantageously automatically by means of software or a data processing program, by means of a derived construction geometry 7 onto a processing region of the construction platform 1 (cf. method step b) in FIG. 4).

The projection of the construction geometry 7 may also be output by a data processing program automatically to a tool for a subsequent mechanical processing step for the construction platform 1.

The method subsequently comprises mechanical processing (cf. method step c) in FIG. 4), in particular material-removing processing of the construction platform 1 in lateral regions of the construction platform into which the component geometry has not been transferred. In this way, in the processing region 4, surface regions 5 of the construction platform 1 are exposed, which need to be filled or coated with the base material 15 for the additive construction of the component, in particular before the solidification of the first component layer (the situation is not explicitly represented in FIG. 2).

The aforementioned coating may, however, be carried out from above, i.e. for example by introducing powder from a powder reservoir arranged above the construction platform, or by a standard coater, during which the construction platform 1 is advantageously not lowered since the construction geometry 7 (as described above) already exists.

In other words, for example, the first 5 mm (with a corresponding thickness of the processing region 4) corresponding to the first layer, to be produced additively, of the component are transferred as a setpoint geometry onto the construction platform 1.

The result is a construction geometry 7 in the construction platform 1 which provides a construction surface AF as a production surface for the component 10 subsequently to be produced additively. In this case, however, the substrate material—in contrast to the situation of FIG. 1—may advantageously be used for providing the processing region. Accordingly, the structure of the component 10 is represented directly on the platform structure of the processing region 4 in FIG. 2.

In a similar way to the description of FIG. 1, the processing region 4 comprises along a construction direction AR first a separation region 3 and, above this, a finishing region 2 in which separation and/or (mechanical) finishing of the construction platform 1 for the component 10 may subsequently be carried out.

Correspondingly, the method furthermore comprises additive construction of the component on the construction surface AF (cf. method step d) in FIG. 4). This may also comprise a heat treatment (cf. method step dd) in FIG. 4), which in particular is unavoidable when processing components from superalloys, in order to reduce the stresses created during the construction, which result from the high temperatures and temperature gradients involved.

As shown in FIG. 1, the component 10 has likewise been constructed with a cavity 8 which is intended to have an opening only downward, i.e. on a side facing toward the construction platform 1.

The situation shown in FIG. 2 advantageously corresponds to an instant in the method according to the invention between steps d) and e) or dd) and e) (cf. FIG. 4), i.e. before a subsequent separation step in which the component 10 is separated from the substrate plate or construction platform 1 (see above and method step e) in FIG. 4).

The described method may, as indicated in FIG. 2, comprise a further method step (cf. method step ddd) in FIG. 4), in which the construction platform 1 including the processing region 4 as well as a part of the component 10 has been mechanically opened, for example bored or milled, from below, i.e. through the construction platform, in order to remove the powder or base material 15 from the cavity 8. As described above, this is advantageously possible by the method according to the invention without the material of the component 10 itself having to be subjected to mechanical processing.

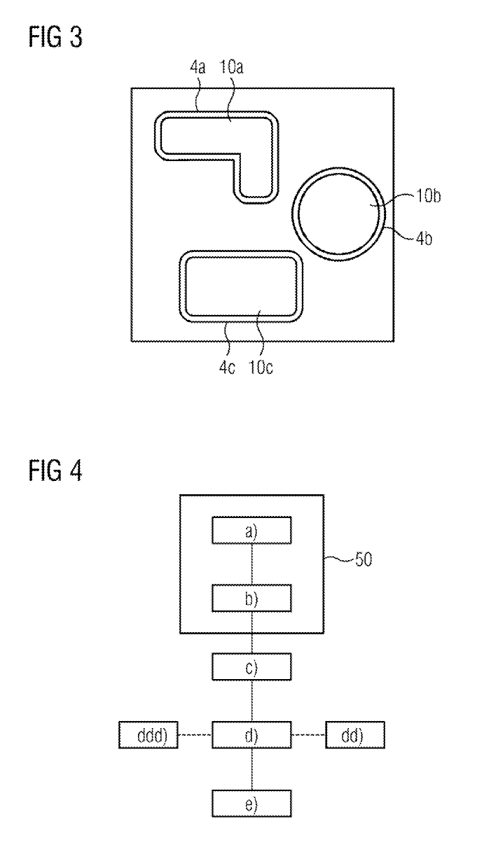

FIG. 3 shows a schematic plan view of the construction platform 1. It is shown in particular that a multiplicity of components 10a, 10b and 10c are arranged and constructed on the construction platform 1. In a different way from the geometries shown, these may have any other shape or contour. FIG. 3 illustrates (this aspect is not represented in FIG. 2) that a construction geometry (cf. reference signs 7a, 7b and 7c) may differ from the component geometry, in particular may be derived therefrom. This means advantageously that the construction geometries 7a, 7b, 7c may differ from the actual component geometries by an additional oversize. The aforementioned oversize, however, is advantageously taken into account during the mechanical processing of the construction platform 1, for example in order to compensate for possible position deviations during the exposure or solidification during the construction of the component, or to provide a tolerance.

In FIG. 4, a schematic flowchart of the method steps of the method according to the invention is shown. Those method steps which are not compulsory are represented by dashes. The box around method steps a) and b) schematically indicates that these method steps may be carried out automatically or semiautomatically by a data processing device 50 (cf. above).

The description with the aid of the exemplary embodiments does not restrict the invention to these exemplary embodiments; rather, the invention comprises any new feature and any combination of features. This includes in particular any combination of features in the patent claims, even if this feature or this combination per se is not explicitly indicated in the patent claims or exemplary embodiments.

1.-15. (canceled)

16. A method for the additive production of a component, comprising:
a) recording of a component geometry of a first region, to be produced additively, of the component,
b) transfer of a construction geometry, derived from the recorded component geometry, into a processing region of a construction platform,
c) mechanical processing of the construction platform in the processing region, in such a way that the construction geometry is transferred into the structure of the construction platform so that a construction surface for the component is defined by the construction geometry, wherein the processing region represents an oversize region on the surface of the construction platform, over which separation of the component as well as mechanical finishing for the component may be carried out after the construction, and
d) additive construction of the component on the construction surface.

17. The method as claimed in claim 16,
wherein the recording of the component geometry and/or the transfer of the construction geometry are carried out with computer assistance or by a data processing program.

18. The method as claimed in claim 16,
wherein the projection of the construction geometry is output automatically by a data processing program to a tool for the mechanical processing of the construction platform.

19. The method as claimed in claim 16,
wherein the construction geometry is derived from the recorded component geometry during the transfer by providing the construction geometry with a predetermined lateral dimension.

20. The method as claimed in claim 16, further comprising:
after the additive construction, e) separating the component from the construction platform in the processing region.

21. The method as claimed in claim 16,
wherein, during the transfer, a thickness of the processing region is selected as a function of a separation method for the subsequent separation of the component, and a selection of values is automatically proposed for the thickness.

22. The method as claimed in claim 16,
wherein a thickness of the processing region is between 3 and 10 mm.

23. The method as claimed in claim 16,
wherein the additive construction is carried out by a powder bed-based method.

24. The method as claimed in claim 23,
wherein surface regions of the construction platform which have been exposed by the mechanical processing are coated with a base material in powder form for the component, without the construction platform being lowered.

25. The method as claimed in claim 23,
wherein the component is provided during the additive construction with a cavity which is open only on a side facing toward the construction platform, and wherein the cavity is mechanically opened through the construction platform before subsequent separation of the constructed component from the construction platform and before a heat treatment of the component, in such a way that a base material in powder form for the component, which has correspondingly been enclosed in the cavity of the component during the additive construction, is removeable through the construction platform.

26. The method as claimed in claim 16,
wherein the construction platform comprises steel as a main constituent, and wherein the component is produced from a high-temperature stable material, a superalloy, and/or a nickel-based alloy.

27. The method as claimed in claim 16, further comprising:
parallel additive construction of a multiplicity of components,
wherein a multiplicity of component geometries of the components being recorded and a multiplicity of derived construction geometries correspondingly being transferred into the processing region,
wherein the construction platform is mechanically processed according to the multiplicity of construction geometries and the multiplicity of components are additively constructed on the corresponding construction surfaces.

28. A non-transitory computer-readable medium comprising executable program instructions that enable a data processing device to carry out the following steps:
recording of a component geometry of a first region, to be produced additively, of the component; and
transfer of a construction geometry, derived from the recorded component geometry, into a processing region of a construction platform, as claimed in claim 16.

29. A computer program product, comprising:
executable program instructions stored on a non-transitory computer-readable medium which, when the program is run by a data processing device, cause the data processing device to carry out the method as claimed in claim 16.

30. The method as claimed in claim 20, further comprising:
after the additive construction, e) separating the component from the construction platform in the processing region by at least one of the following methods: erosion, sawing, milling, grinding and striking.

31. The method as claimed in claim 22,
wherein a thickness of the processing region is 5 mm.
